(19) United States
(12) Patent Application Publication
(10) Pub. No.: US 2019/0361366 A1
(43) Pub. Date: Nov. 28, 2019

(54) LIQUID DEVELOPER AND METHOD FOR PRODUCING PRINTED MATERIAL

(71) Applicants: TOYO INK SC HOLDINGS CO., LTD., Tokyo (JP); TOYO INK CO., LTD., Tokyo (JP)

(72) Inventors: Yuji SONETA, Tokyo (JP); Tsuyoshi TSURUTA, Tokyo (JP); Norio SUZUKI, Tokyo (JP)

(73) Assignees: TOYO INK SC HOLDINGS CO., LTD., Tokyo (JP); TOYO INK CO., LTD., Tokyo (JP)

(21) Appl. No.: 16/477,182

(22) PCT Filed: Dec. 21, 2017
(86) PCT No.: PCT/JP2017/046003

§ 371 Date: Jul. 10, 2019

(30) Foreign Application Priority Data
Jan. 13, 2017 (JP) 2017-003855

(51) Int. Cl. G03G 9/13; G03G 9/125; G03G 15/10

(52) U.S. Cl. CPC G03G 9/131; G03G 15/104; G03G 9/125; G03G 9/132

(57) ABSTRACT

A liquid developer, which can stably and continuously produce high-quality images without carrier liquid bleeding and which can further provide excellent anti-cold-offset property and fixability. The liquid developer comprises at least: a toner particle comprising a binder resin (A) and a colorant (B); and a carrier liquid (C); wherein the binder resin (A) has an acid value within the range of 20 to 40 mgKOH/g, and the carrier liquid (C) is a non-aromatic hydrocarbon comprising an isoparaffin, wherein the carrier liquid (C) has an initial boiling point within the range of 200 to 250° C. and a dry point within the range of 300 to 450° C., and the difference between the dry point and the initial boiling point is 80 to 200° C.

### TECHNICAL FIELD

The present invention relates to a liquid developer, and to a method for producing a printed material by using the liquid developer.

### BACKGROUND ART

A liquid developer is an electrically insulating carrier liquid having toner particles dispersed therein, wherein the toner particles are composed of a coloring agent, a binder resin, and optionally additives such as dispersing agents. The toner particles can be made finer in a liquid developer compared to the dry powder-type toners. Furthermore, since the liquid developer uses a carrier liquid which is an insulating liquid, it does not cause the problem of scattering etc. of the toner particles inside the image-forming apparatus. Therefore, the image-forming apparatus using a liquid developer is characterized by the ability to form high-quality, high-definition images. In order to take advantage of these characteristics of the liquid developers and to obtain high-quality images, the toner particles in the carrier liquid are required to show stable dispersion within the carrier liquid in addition to the abilities to color, be fixed, and be electrically charged (Patent Documents 1 and 2).

In an electrophotography-type image-forming apparatus using a liquid developer, the electrostatic latent image formed by the photographic exposure is developed by using the toner particles in the carrier liquid, and following the development, the obtained electrostatic latent image is transferred, dried, and fixed onto a recording medium such as paper to form an image. During the process, it is inevitable that the carrier liquid is also transferred to the recording medium. Upon the transfer of the carrier liquid onto the recording medium, if the carrier liquid is not completely evaporated in the drying process or in the fixing process, in will remain on the recording medium as a carrier liquid bleeding and may cause impairment of the image quality. In order to facilitate the evaporation, it is necessary to use a carrier liquid having a low boiling temperature. However, if the boiling temperature of the carrier liquid is too low, the liquid developer can dry/adhere onto the developer-holding structure or the electrostatic latent image-holding structure of the image forming apparatus, for example, and operating the apparatus in such a condition may possibly damage the holding structures and cause deterioration of the image quality and continuous printing stability. Therefore, conventionally, the carrier liquid remaining on the electrostatic latent image-holding structure, the intermediate transfer structure, or the recording medium is removed by removal means such as rollers and blades before or after the drying process (See Patent Documents 3, 4 and 5).

Further, in an electrophotography-type image-forming apparatus using a liquid developer, in general, a non-contact charging device (e.g. corotron charging apparatus and scorotron charging apparatus) is used as a charging device for the electrostatic latent image-holding structure. However, the use of the charging device generates ozone, which tends to oxidize the components in the vicinity including the liquid developer. The carrier liquid included in the liquid developer is especially prone to oxidization, and its oxidization products will adhere to and be deposited on the electrostatic latent image-holding structure and the likes to inhibit the formation of the electrostatic latent image, also causing the problematic deterioration of the image quality and continuous printing stability. Especially, when the carrier liquid has a low boiling temperature, the carrier liquid evaporated inside the image-forming apparatus will be oxidized by the ozone and stick to the charging device, which could render the charging function uneven and deteriorate the image quality.

Patent Document 6 describes adding an antioxidant to a liquid developer. Although the use of the antioxidant could indeed suppress the ozone-induced oxidation of the carrier liquid, it could also negatively affect the performance in other aspects, e.g. loss of image density due to the lowering of the chargeability of the toner particles and decrease in the fixability on the recording medium and the storage stability.

### CITATION LIST

### Patent Literature

### [Patent Document 1] JP H05-333607 A

### [Patent Document 2] JP 2007-505953 A

### [Patent Document 3] JP 2009-080460 A

### [Patent Document 4] JP 2009-116304 A

### [Patent Document 5] JP 2009-282280 A

### [Patent Document 6] JP 2008-242039 A

### SUMMARY OF INVENTION

### Technical Problem

Thus, there has been a need for improvement to obtain a liquid developer which can stably and continuously produce high-quality images without carrier liquid bleeding, and which can further provide good anti-cold-offset property and fixability.

An objective of the present invention is provision of a liquid developer which can stably and continuously produce high-quality images without carrier liquid bleeding and which can further provide good anti-cold-offset property and fixability. Another objective of the present invention is provision of a printed material which is stably and continuously obtainable by using the liquid developer.

### Solution to Problem

As a result of the extensive research for solving the above-mentioned problems, the present inventors discovered that the embodiments described below can solve the problems, which led to the completion of the invention.

The present invention relates to a liquid developer comprising at least: a toner particle comprising a binder resin (A) and a colorant (B); and a carrier liquid (C); wherein the binder resin (A) has an acid value within the range of 20 to 40 mgKOH/g, and the carrier liquid (C) is a non-aromatic hydrocarbon comprising an isoparaffin, wherein the carrier liquid (C) has an initial boiling point within the range of 200 to 250° C. and a dry point within the range of 300 to 450° C., wherein the difference between the dry point and the initial boiling point is 80 to 200° C.

The present invention also relates to the liquid developer further comprising a dispersing agent (D).

The present invention also relates to the liquid developer wherein the binder resin (A) comprises one or more resins selected from the group consisting of polyester resin, styrene resin, (meth)acryl resin, and styrene-(meth)acryl copolymer resin.

The present invention also relates to the liquid developer wherein the binder resin (A) comprises a polyester resin and one or more styrene/acryl resins selected from the group consisting of styrene resin, (meth)acryl resin, and styrene-(meth)acryl copolymer resin, wherein the styrene/acryl resin comprises a monomer having an aromatic ring within the range of 60 to 100% by mass in the total monomers constituting the styrene/acryl resin.

The present invention also relates to the liquid developer produced by a method comprising wet-grinding a melt-kneaded mixture of the binder resin (A) and the colorant (B) in the carrier liquid (C).

The present invention also relates to a method of producing a printed material obtained by using the liquid developer.

### Effects of Invention

According to the present invention, it is possible to provide a liquid developer which can stably and continuously produce high-quality images without carrier liquid bleeding, and which can further provide good anti-cold-offset property and fixability. It is also possible to provide a printed material obtained stably and continuously by using the liquid developer.

### DESCRIPTION OF EMBODIMENTS

Below, the invention will be described in detail.

A main characteristic of the liquid developer according to an embodiment of the present invention (hereinafter referred to as the present embodiment) is that it is a liquid developer comprising at least: a toner particle comprising a binder resin (A) and a colorant (B); and a carrier liquid (C); wherein the binder resin (A) has an acid value within the range of 20 to 40 mgKOH/g, and the carrier liquid (C) is a non-aromatic hydrocarbon comprising an isoparaffin, wherein the carrier liquid (C) has an initial boiling point within the range of 200 to 250° C. and a dry point within the range of 300 to 450° C., wherein the difference between the dry point and the initial boiling point (hereinafter, this difference is also referred to as a distillation range) is 80 to 200° C.

As mentioned above, when a solvent with high volatility is used as a carrier liquid, it could provide a good drying ability following the transfer to the recording medium, but on the other hand, it could also evaporate/dry within the image-forming apparatus, allowing the components of the liquid developer to stick to the electrostatic latent image-holding structure and/or become oxidized by the ozone generated from the charging device, which could deteriorate the continuous printing stability. Conversely, when a solvent with low volatility is used, it could prevent the evaporation/drying on the image-forming apparatus, but the carrier liquid components may remain on the recording medium following the drying/fixing processes thereon, which could result in carrier liquid bleeding. The attempts to benefit from both types, by merely choosing a solvent having a broad distillation range or by mixing two or more solvents having different evaporation properties, still could not escape the above-mentioned tradeoffs.

In view of these difficulties the present inventors conducted extensive research, and discovered that it is in fact possible to escape the tradeoffs by the combinational use of: the carrier liquid (C) which is a non-aromatic hydrocarbon comprising an isoparaffin having a broad distillation range and a specific initial boiling point and a specific dry point; and the binder resin (A) having an acid value within the range of 20 to 40 mgKOH/g. Although the basis for this is not understood in detail, at present, the mechanism described below is believed to be at work.

In the liquid developer of the present embodiment, the carrier liquid (C) is a non-aromatic hydrocarbon comprising an isoparaffin, wherein the carrier liquid (C) has an initial boiling point within the range of 200 to 250° C., a dry point within the range of 300 to 450° C., and a distillation range of 80 to 200° C. By including the low volatility solvent, the drying on the image-forming apparatus can be suppressed, thereby good continuous printing stability can be maintained. On the other hand, during the drying process after the transfer to the recording medium, the high volatility components evaporate preferentially, leaving behind a relatively high amount of the low volatility components on the recording medium. Here, the components with lower volatility have lower affinity for the binder resin (A) used in the liquid developer of the present embodiment, and therefore, as the drying progresses, the separation of the carrier liquid from the toner particles comprising the binder resin (A) is facilitated. The facilitated separation of the carrier liquid in turn facilitates the progressive evaporation of the carrier liquid free from the interference from the toner particles. Coincidentally, the cohesion between the toner particles is promoted, resulting in a sharper image showing no oozing of the toner particles and hence improvement of the image quality.

By the time of the fixing process, the carrier liquid in the liquid developer on the recording medium only contains a small amount of remaining low volatility carrier liquid components. By retaining a certain amount of the low volatility components on the recording medium on purpose, the high boiling point components can function like a fixation oil that prevents adhesion of the toners to the fixing unit, significantly improving the anti-cold-offset property. Also, by using the non-aromatic hydrocarbon having the said boiling temperature range, the remaining low volatility carrier liquid components can be evaporated sufficiently by the energy of the fixing process, and the energy can be transmitted evenly to the entire toners on the recording medium through the carrier liquid components, improving the fixability of the toner particles. The final result is a printed material characterized by the lack of remaining carrier liquid after the fixing process and by good fixation.

As outlined above, the constitution of the liquid developer of the present embodiment is essential for solving the problem addressed by the present invention, i.e. to simultaneously satisfy all of the following requirements: prevention of carrier liquid bleeding, image quality, continuous printing stability, anti-cold-offset property, and fixability.

Below, the binder resin (A), colorant (B), carrier liquid (C) and others comprised in the liquid developers of the embodiments of the invention will be described in detail.

### (Toner Particles)

The toner particle used in the liquid developer comprises at least a binder resin (A) and a colorant (B). It may additionally comprise a pigment dispersing agent, a charge controlling agent, a release agent, and the likes. If a dispersing agent (D) described below is used, it is preferably added when the toner particles are wet-dispersed in the carrier liquid (C), but it may also be added into the toner particles when the toner particles are prepared.

### (Binder Resin (A))

### (Acid Value)

In general, a binder resin is required to have the function of evenly dispersing the colorant in the resin, as well as the function as a binder for fixation onto the recording medium such as paper. As described below, the binder resin (A) in the liquid developer of the present embodiment is required to have an acid value within the range of 20 to 40 mgKOH/g, and more preferably within the range of 20 to 37 mgKOH/g, especially preferably 21 to 35 mgKOH/g. By having the acid value within the said range, the affinity for the low-volatility components of the carrier liquid (C) can be held within a preferable range, thereby promoting the separation from the carrier liquid. Preferable volatility of the carrier liquid (C) is achieved by this, realizing the improvement of the anti-cold-offset property and fixability during the fixing process and betterment of the image quality. If the acid value of the binder resin (A) is smaller than 20 mgKOH/g, its adsorbing power may become insufficient even if a dispersing agent (D) is present, resulting in poor storage stability. If the acid value is greater than 40 mgKOH/g, the adsorption of the dispersing agent (D) may become excessive, resulting in poor fixability. When the dispersing agent is adsorbed excessively, the charge-sustaining ability of the toner particles also tends to become lower. The acid value can be measured by using the “Automatic Potentiometric Titrator AT-610” which is a product of Kyoto Electronics Manufacturing Co., Ltd.

For the binder resin (A) in the liquid developer of the present embodiment, any known binder resins may be used, either a single type or two or more types in mixture. Among others, one or more resins selected from the group consisting of polyester resins, styrene resins, (meth)acryl resins, and styrene-(meth)acryl copolymer resins are preferably comprised. The binder resin (A) preferably comprises no less than 80% by mass, more preferably no less than 90% by mass, still more preferably no less than 95% by mass of one or more resins selected from the group consisting of polyester resins, styrene resins, (meth)acryl resins, or styrene-(meth)acryl copolymer resins. The binder resin (A) may consist of one or more resins selected from the group consisting of polyester resins, styrene resins, (meth)acryl resins, and styrene-(meth)acryl copolymer resins. These resins have many types of monomers available for the raw materials, and therefore their acid values etc. can be relatively easily adjusted compared to other resins. Among the above-mentioned resins, the polyester resins are especially preferably used. In the interest of improving fixability and anti-cold-offset property, the binder resin preferably has a lower molecular weight and hence a lower melt viscosity, but on the other hand this may also increase the likelihood of hot offset due to the excessive melting. By choosing a polyester resin, hot offset can be prevented even at a low molecular weight, due to the quasi high molecular weight state effected by the inter-molecular hydrogen bonding, resulting in a liquid developer simultaneously satisfying anti-cold-offset property, anti-hot-offset property, and fixability. The binder resin (A) preferably is colorless, transparent, white, or has a pale color so that it does not interfere with the hues of the colorants of each color.

When a polyester resin is used as a binder resin (A), it is preferably a thermoplastic polyester due to the applicability of the fixation method in which the toner particles are fixed by heat-melting, which is a common fixation method for liquid developers in general. Especially preferable is a polyester resin obtainable by condensation polymerization of an alcohol having a valency of 2 or greater and a carboxylic acid having a valency of 2 or greater.

Examples of the alcohols having a valency of 2 or greater include: divalent alcohols such as ethylene glycol, 1,2-propanediol, 1,3-propanediol, 1,3-butanediol, 1,4-butanediol, 2,3-butanediol, 1,4-butenediol, diethylene glycol, triethylene glycol, 1,5-pentanediol, 1,6-hexanediol, neopentyl glycol, 2-ethyl-1,3-hexanediol, bisphenol A, hydrogenated bisphenol A, bisphenol derivative expressed by General Formula (1) below, and 1,4-cyclohexanedimethanol; and alcohols having a valency of 3 or greater such as glycerol, diglycerol, sorbit, sorbitan, butanetriol, trimethylolethane, trimethylolpropane, pentaerythritol, dipentaerythritol, and tripentaerythritol. One type of these alcohols may be used alone or two or more types may be used in combination.

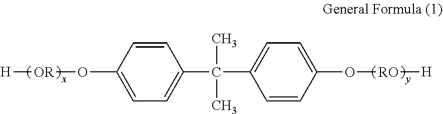

In General Formula (1), R is ethylene or propylene group, x and y are each an integer of no smaller than 1, and the average of x+y is within the range of 2 to 10.

Examples of the carboxylic acids having a valency of 2 or greater include: benzene dicarboxylic acids and anhydrides thereof such as phthalic acid, terephthalic acid, isophthalic acid, and phthalic anhydride; alkyl dicarboxylic acids and anhydrides thereof such as succinic acid, adipic acid, sebacic acid, and azelaic acid; succinic acid and anhydride thereof substituted with an alkyl group having 16 to 18 carbons; unsaturated dicarboxylic acids and anhydrides thereof such as fumaric acid, maleic acid, citraconic acid, itaconic acid, and glutaconic acid; cyclohexane dicarboxylic acid, naphthalene dicarboxylic acid, diphenoxyethane-2,6-dicarboxylic acid and anhydrides thereof; rosin derivative divalent carboxylic acids and the likes such as acrylic acid modified rosins; and carboxylic acids having a valency of 3 or greater such as trimellitic acid, pyromellitic acid, naphthalenetricarboxylic acid, butanetricarboxylic acid, hexanetricarboxylic acid, tetra(methylenecarboxyl)methane, octanetetracarboxylic acid, benzophenonetetracarboxylic acid, and anhydrides thereof. One type of these carboxylic acids may be used alone or two or more types may be used in combination.

Preferred alcohols having a valency of 2 or greater among those listed above include bisphenol derivative expressed by General Formula (1), ethylene glycol, neopentyl glycol, 1,3-propanediol, 1,4-butanediol, 1,5-pentanediol, and 1,6-hexanediol. Preferred carboxylic acids having a valency of 2 or greater among those listed above include: phthalic acid, terephthalic acid, isophthalic acid and anhydrides thereof; succinic acid, n-dodecenylsuccinic acid and anhydrides thereof; fumaric acid, maleic acid, and maleic anhydride; and trimellitic acid and anhydride thereof. The alcohols or carboxylic acids containing aromatic moieties are especially preferred, with respect to the pigment dispersion characteristics and charging characteristics as well as the ability to provide the liquid developer with good anti-cold-offset and anti-hot-offset properties even at a low molecular weight due to the inter-molecular forces such as π-π interactions generated between the resin molecules.

When a polyester resin is used as a binder resin (A), it may be synthesized by a known synthesis method such as condensation polymerization, or it may be a commercially available resin. For condensation polymerization, the acid values as well as molecular weights and softening temperatures of the binder resins (A) may be controlled by adjusting the types and molar ratios of the reactant alcohols and carboxylic acids, as well as the reaction temperatures, reaction times, reaction pressures, catalysts, and the likes. For commercially available resins, the acid values of the binder resins (A) as well as the thermal characteristics and the powder characteristics of the toner particles may be controlled at will by combining two or more types and adjusting the mix ratios. Specific examples of preferably used, commercially available polyester resins include Diacron ER-502, Diacron ER-508 (both from Mitsubishi Rayon Co., Ltd.), and the likes.

When one or more types of resins selected from the group consisting of styrene resin, (meth)acryl resin, and styrene-(meth)acryl copolymer resin (hereinafter collectively called styrene/acryl resins) are used as binder resin (A), the dispersion stability of the colorant (B) and the charging characteristics as well as the anti-cold-offset property and anti-hot-offset property may be improved, as with the polyester resins described above, by introducing aromatic rings in the resins. The inclusion of at least styrene-(meth)acryl copolymer resin is preferable, since it will allow controls over the binder resin (A) characteristics based on the combinations of various monomers. “(Meth)acryl” refers to at least one type selected from the group consisting of “acryl” and “methacryl”. “Styrene-(meth)acryl copolymer resin” refers to a resin obtainable by polymerizing at least one type selected from styrene-based monomers and at least one type selected from (meth)acrylic acid and (meth)acrylic acid ester.

Styrene-based monomers that can constitute the styrene resins or the styrene-(meth)acryl copolymer resins include styrene, o-methylstyrene, m-methylstyrene, p-methylstyrene, a-methylstyrene, p-ethylstyrene, 2,4-dimethylstyrene, p-n-butylstyrene, p-tert-butylstyrene, p-n-hexylstyrene, p-n-octylstyrene, p-n-nonylstyrene, p-n-decylstyrene, p-n-dodecylstyrene, p-methoxystyrene, p-phenylstyrene, p-chlorostyrene, 3,4-dichlorostyrene, and the likes. Among these, the inclusion of styrene is especially preferable due to the particularly good improvement of the dispersibility of the colorant (B) and the betterment of the image quality.

Specific examples of the acryl-based monomers that can constitute the (meth)acryl resins or the styrene-(meth)acryl copolymer resins include: (meth)acryl esters such as methyl (meth)acrylate, ethyl (meth)acrylate, propyl (meth)acrylate, butyl (meth)acrylate, isobutyl (meth)acrylate, octyl (meth)acrylate, 2-ethylhexyl (meth)acrylate, lauryl (meth)acrylate, dodecyl (meth)acrylate, stearyl (meth)acrylate, 2-chloroethyl (meth)acrylate, phenyl (meth)acrylate, dimethyl aminoethyl acrylate, and diethyl aminoethyl (meth)acrylate; and poly-functional monomers such as divinyl benzene, diethylene glycol di(meth)acrylate, triethylene glycol di(meth)acrylate, 1,6-hexanediol di(meth)acrylate, neopentyl glycol di(meth)acrylate, and trimethylolpropane tri(meth)acrylate. Among these, the inclusion of at least one type selected from butyl (meth)acrylate, octyl (meth)acrylate, or 2-ethylhexyl (meth)acrylate is especially preferable because good dispersion of the release agent, pigment dispersant, etc. described below can be obtained when they are used with the binder resin.

When a styrene/acryl resin is used as binder resin (A), the resin can be synthesized by any of the known polymerization methods such as suspension polymerization, solution polymerization, and emulsion polymerization, or it can be a commercially available resin. If the resin is synthesized by the suspension polymerization method or the like, the acid value of the binder resin (A) as well as the molecular weight and softening temperature of the resin can be controlled by adjusting the monomer types used and their molar ratios, as well as reaction temperature, reaction time, reaction pressure, polymerization initiator, crosslinker, etc. If commercially available resins are used, the acid value of the binder resin (A) as well as thermal characteristics and powder characteristics of the toner particles can be controlled at will by combining two or more resin types and adjusting the mix ratios. Specific examples of preferably used, commercially available resins include Almatex CPR100, CPR200, CPR300, CPR600B (products of Mitsui Chemicals), and the likes.

When a styrene/acryl resin is used as binder resin (A), it is especially preferable if it includes 60 to 100% by mass (no lower than 60% by mass), in the total amount of the monomers, of a monomer having an aromatic ring. This is because the high amount of the monomer having an aromatic ring can improve not only the dispersibility of the colorant (B) and the image quality such as print density, but also, as with the polyester resins described above, fixability, anti-cold-offset property and anti-hot-offset property.

In the liquid developer of the present embodiment, it is preferable to use as the binder resin (A) a polyester resin and a styrene/acryl resin together, due to the improvement of the grindability during the toner particle manufacturing and the dispersion stability, the improvement of the charging property based on the low relative permittivity and hence the betterment of the image quality, and the improvement of the fixability and anti-cold-offset property based on the especially ideal balance of acid values and melt characteristics. The binder resin (A) preferably comprises 80% by mass or more, more preferably 90% by mass or more, still more preferably 95% by mass or more, of polyester resin(s) and styrene/acryl resin(s), combined. The binder resin (A) may consist only of polyester resin(s) and styrene/acryl resin(s). It is especially preferable if the binder resin (A) comprises both polyester resin(s) and styrene/acryl resin(s) or consists of polyester resin(s) and styrene/acryl resin(s), and the styrene/acryl resin(s) include 60 to 100% by mass (no lower than 60% by mass), in the total amount of the monomers constituting the styrene/acryl resin(s), of a monomer having an aromatic ring.

When a polyester resin and a styrene/acryl resin are used together in the binder resin (A), they may be uniformly mixed/dispersed in the toner particles, or they may be present in such a way that one of the resins covers at least part of the other resin. However, in the latter case, at least the outer resin may need to be insoluble to the carrier liquid (C). If the binder resin (A) comprises a polyester resin only and the dispersing agent (D) described below is a styrene/acryl resin soluble to the carrier liquid (C), for example, then the soluble dispersing agent (D), which is a styrene/acryl resin, could cover up the toner particles comprising the polyester resin as the sole binder resin (A) in the liquid developer. This situation is however not considered to represent the condition in which “a polyester resin and a styrene/acryl resin are used together” in the binder resin (A) of the toner particles.

The methods for obtaining a binder resin (A) in which a polyester resin and a styrene/acryl resin are used together include: the method of melt-kneading the polyester resin and the styrene/acryl resin; the method which comprises dissolving each of the polyester resin and the styrene/acryl resin in a solvent, mixing the two solutions, and removing the solvents; the method which comprises, in the presence of either of the polyester resin or the styrene/acryl resin, adding the monomers for forming the other resin and effecting polymerization; and the methods described by the patent application publications JP H07-120976 and JP 2006-178296. In the liquid developer of the present embodiment, these two resins are preferably uniformly mixed/dispersed. In the interest of obtaining such a binder resin, a preferred method is the method which comprises, in the presence of either of the polyester resin or the styrene/acryl resin, adding the monomers for forming the other resin and effecting polymerization. An especially preferred method is the method which comprises condensation-polymerizing a polyester resin in bulk polymerization and then dissolving the obtained polyester resin in a solvent, followed by addition of the monomers for forming a styrene/acryl resin to effect the synthesis in a solution polymerization with some heating as needed, and then removal of the solvent.

When the binder resin (A) constituting the liquid developer of the present embodiment comprises both a polyester resin and a styrene/acryl resin, the mass ratio of the polyester resin to the styrene/acryl resin is preferably between 1:1 and 99:1, inclusive, more preferably between 2:1 and 49:1, inclusive. The mass ratio is preferably within this range because it will result in highly pulverizable toner particles, which improves the chromogenic property and the storage stability of the liquid developer, and further result in a melt property in a suitable range which improves the anti-cold-offset property.

The amount of the binder resin (A) comprised in the toner particles is preferably 60 to 95% by mass, more preferably 70 to 90% by mass, relative to 100% by mass of the toner particles. Sixty percent or more by mass is preferable because the fixability and the anti-offset property can be improved, and 95% or less by mass is preferable because the ratio of the binder resin (A) to the colorant (B) becomes small, which can improve the coloring properties of the toner particles and increase the image density.

### (Softening Temperature (T4))

The softening temperature of the binder resin (A) is preferably within the range of 80 to 140° C., more preferably 90 to 130° C. The softening temperature can be measured by using “Flow Tester CFT-500D” of Shimadzu Corporation, for example. Specifically, the softening temperature (T4) is a temperature at which the piston applying the load to 1.0 g of the sample is lowered by 4 mm after the initiation of the measurement under the following conditions: the initiation temperature is 40° C., the pre-heating time is 300 seconds, and the rate of the temperature rise is 6.0° C./min; the test load is 20 kgf, the die opening diameter is 0.5 mm, and the die opening length is 1.0 mm.

If the softening temperature of the binder resin (A) is 80° C. or higher, the toner particles will contact with the heat press roller surface in a molten state during the fixing process of the image outputting, making the cohesive forces of the toner particles greater than the adhesive forces between the toner particles and the heat press roller, which can make a hot-offset incident less likely. If the softening temperature is 140° C. or lower, good fixability can be obtained, and further, the grindability can be improved and the coloring properties can be enhanced.

### (Weight Average Molecular Weight (Mw))

For anti-cold-offset and anti-hot-offset properties, fixability, and image quality, the binder resin (A) preferably has a weight average molecular weight (Mw) within the range of 2,000 to 100,000, more preferably 5,000 to 50,000, based on the molecular weight measured by gel permeation chromatography (GPC). If the weight average molecular weight (Mw) of the binder resin (A) is 2,000 or higher, the anti-hot-offset property, color reproducibility, and dispersion stability can be improved, and if it is 100,000 or lower, the fixability and anti-cold-offset property can be improved. The binder resin (A) can be either of: the type having a dual-peak molecular weight distribution curve comprising certain low molecular weight polycondensate components and certain high molecular weight polycondensate components; or the type having a single-peak molecular weight mono-distribution curve.

The weight average molecular weight (Mw) to the number average molecular weight (Mn) ratio Mw/Mn as measured by GPC is preferably between 2 and 20, inclusive. With Mw/Mn of 2 or higher, the anti-offset properties can be enhanced and the anti-offset range broadened, improving the low-temperature fixability. With Mw/Mn of 20 or lower, the grindability of the toner particles can be increased and satisfactory image density obtained, resulting in the improvements of image characteristics such as enhancement of the coloring properties.

The weight average molecular weight and the molecular weight distribution based on the GPC can be measured by using the Tosoh Corporation Gel Permeation Chromatography (HLC-8220) under the following conditions: The column is stabilized in a heat chamber at 40° C. In the column at this temperature, tetrahydrofuran (THF) as a solvent is flowed at a flow rate of 0.6 mL per minute, and 10 μL of the test solution dissolved in THF is injected to make a measurement. In the molecular weight measurement of the sample, the molecular weight distribution of the sample is calculated from the counts in relation to the logarithm values of the standard curve obtained from several types of mono-dispersed polystyrene standard samples.

For the standard polystyrene samples for making the standard curve, ten samples of polystyrenes having the molecular weights of around 10² to 10⁷ manufactured by Tosoh Corporation may be used. For the detector, an RI (refractive index) detector may be used. For the column, 3 columns of TSKgel SuperHM-M (Tosoh Corporation) may be used. The samples for the measurement may be prepared by leaving the sample in THF for several hours and then mixing the sample and the THF thoroughly until no undissolved sample remains, and further leaving it undisturbed for 12 hours or longer. In this preparation, the sample concentration (resin concentration) is adjusted to 0.5 to 5 mg/mL

### (Colorant (B))

The colorants (B) that may be used in the liquid developer of the present embodiment include, for example, the organic pigments, the organic dyes and salt-forming compounds thereof and the inorganic pigments described below. A single type of these may be used alone or two or more types may be used in combination. The colorant (B) is preferably insoluble to the carrier liquid (C).

Yellow organic pigments that may be used include benzimidazolone compounds, condensed azo compounds, isoindolinone compounds, anthraquinone compounds, quinophthalone compounds, azo metal complex compounds, methine compounds, acrylamide compounds, and the likes. Quinophthalone compounds, condensed azo compounds, and benzimidazolone compounds are preferred. Specific examples include C.I. pigment yellow 12, 13, 14, 15, 17, 62, 74, 83, 93, 94, 95, 97, 109, 110, 111, 120, 127, 128, 129, 138, 139, 147, 150, 151, 154, 155, 168, 174, 176, 180, 181, 185, 191 and the likes. The salt-forming compounds of yellow dyes may be salt-forming compounds of acidic dyes or basic dyes.

Magenta organic pigments that may be used include condensed azo compounds, diketopyrrolopyrrole compounds, anthraquinones, quinacridone compounds, lake compounds of basic dyes such as rhodamine lakes, naphthol compounds, benzimidazolone compounds, thioindigo compounds, and perylene compounds, and more specifically, C.I. pigment red 2, 3, 5, 6, 7, 23, 48:2, 48:3, 48:4, 57:1, 81, 81:1, 81:2, 81:3, 81:4, 122, 144, 146, 166, 169, 177, 184, 185, 202, 206, 209, 220, 221, 254, 255, 268, and 269, C.I. pigment violet 1 and 19, and the likes. Quinacridone compounds, rhodamine lake compounds, naphthol compounds and the likes are preferable among others, and specifically, naphthol AS (such as C.I. pigment red 269), rhodamine lakes (such as C.I. pigment red 81, 81:1, 81:2, 81:3, 81:4, and 169), quinacridone (such as C.I. pigment red 122), and carmine 6B (C.I. pigment red 57:1) are preferred materials. It is particularly preferable to use a quinacridone pigment and carmine 6B together due to the fact that the liquid developer can thereby present good red coloring property. The salt-forming compounds of the rhodamine-based acidic dyes or rhodamine-based basic dyes can be preferably used as salt-forming compounds of magenta dyes.

Cyan organic pigments that may be used include copper phthalocyanine compounds and derivatives thereof, anthraquinone compounds, basic dye lake compounds, and the likes, and more specifically, C.I. pigment blue 1, 7, 15, 15:1, 15:2, 15:3, 15:4, 15:6, 60, 62, 66, and the likes. Copper phthalocyanine compounds such as C.I. pigment blue 15:3 are preferable among others. The above-mentioned organic pigments may be used in combination with a compound derived from triarylmethane-based dye. Further, a green pigment may be used as a complementary color. Specifically, halogenated phthalocyanine compounds such as C.I. pigment green 7 and 36 may be preferably used.

For black colorants, organic black pigments such as carbon black and perylene black, and organic black dyes such as nigrosine dyes and azo metal complex dyes may be preferably used from the cost and handling points of view. For carbon black, any one of furnace black, channel black, acetylene black, biomass-derived carbon black, and the likes may be used, furnace black and biomass-derived carbon black being preferred due to the image characteristics, i.e. their effects of reducing the fogging (background staining in the white non-printed areas). If a nigrosine dye is used, it is preferable to pulverize the nigrosine base, e.g. by the method described by JP 2006-171501, to a volume average particle size of 0.5 to 2 μm. This pulverized nigrosine dye can present lustrous black color due to its luster. A black liquid developer can be obtained also by mixing multiple color pigments such as yellow, magenta, cyan, green, and violet to substitute for a black colorant. In that case, preferably a black colorant is completely omitted or is included at a proportion within the range of 5 to 40% by mass in the total colorant.

In order to obtain a black color having good image density and contrast, it is especially preferable to use a colorant comprising 1 to 10 parts by mass of a blue colorant added to 100 parts by mass of a black colorant. Metal phthalocyanine blue compounds comprising no halogens, triarylmethane compounds, dioxazine violet pigment or the likes may be used as a blue colorant. Phthalocyanine blue compounds and triarylmethane compounds are especially preferable among others due to their stable positive-charge properties.

For white colorants, titanium oxide is preferably used, which has high refractive index and chemical and physical stability, as well as superior opacity and coloring property as a pigment. The titanium oxide may be treated with an oxide or organometal compound of silicon, aluminum, zirconium, titanium or the like, or with an organic compound. The titanium oxide is preferably treated with at least alumina since it can provide good compatibility with the binder resin (A). Further, inorganic compounds such as basic lead carbonate, zinc oxide, and strontium titanate, or organic compounds such as hollow resin fine particles may be used as white colorants.

The amount of the colorant (B) comprised in the toner particles may be varied depending on the type of the binder resin (A) used, but typically it is 5 to 50 parts by mass, preferably 10 to 30 parts by mass, relative to 100 parts by mass of the toner particles.

### (Carrier Liquid (C))

The carrier liquid (C) used in the liquid developer of the present embodiment needs to have an initial boiling point within the range of 200 to 250° C., preferably within the range of 200 to 230° C. Its dry point needs to be within the range of 300 to 450° C., preferably within the range of 310 to 420° C., more preferably within the range of 320 to 380° C. Further, the difference between the initial boiling point and the dry point needs to fall within the range of 80 to 200° C., preferably within the range of 80 to 175° C., especially preferably within the range of 80 to 150° C. The carrier liquid (C) is preferably chemically inactive to the substances or the devices used within the image-forming apparatus, particularly to the components for the development process such as the electrostatic latent image-holding structure and its surrounding components.

As described above, the carrier liquids having low distillation temperatures in general are easier to remove after the transfer to the recording medium and therefore can prevent the impairment of the image quality caused by carrier liquid bleeding, but they may also accelerate drying of the liquid developer during storage and printing, resulting in inferior storage stability and continuous printability. Conversely, the carrier liquids having high distillation temperatures can avoid the sticking during storage and printing and therefore excel in storage stability and continuous printability, but they may persist on the recording medium even after the drying and fixing, resulting in the impairment of the image quality caused by carrier liquid bleeding

Notably, the liquid developer of the present embodiment can, by combining the specific carrier liquid (C) described here with the binder resin (A) having the specific acid value as described above, prevent the persistence of the components having high distillation temperatures on the recording medium. Further, the research conducted by the present inventors has found that the distillation range of 80 and 200° C. would support the ideal synergy between the high volatility components and the low volatility components for the use in the liquid developer of the present embodiment. Thus, providing a distillation range of 80 and 200° C. is a key point for improving the fixability and the anti-cold-offset property by the preferential drying of the high volatility (high dissolving) components during the drying process and the facilitated carrier liquid separation of the low volatility (low dissolving) components during the fixing process.

The initial boiling point and dry point can be measured by the methods specified by ASTM D86, ASTM D1078, or JIS K2254.

Non-aromatic hydrocarbons include straight-chain (normal) paraffinic hydrocarbons, isoparaffinic hydrocarbons, and naphthenic hydrocarbons, but the carrier liquid (C) in the liquid developer of the present embodiment is a non-aromatic hydrocarbon comprising isoparaffin.

With respect to the resistance to oxidation, it is generally known that the secondary carbons of the hydrocarbon are more prone to oxidization than the primary carbons because the hydrogen atom bound to the secondary carbon atom is more easily pulled off. Isoparaffinic hydrocarbons are less prone to oxidization compared to straight-chain paraffinic hydrocarbons and naphthenic hydrocarbons since the branched structures are accompanied by correspondingly increased numbers of the primary carbons.

Also, in general, the dissolving power of the hydrocarbon-based solvents becomes progressively smaller in the following order: aromatic, naphthenic, isoparaffinic, and normal paraffinic. The aromatic hydrocarbons are less preferable because they have dissolving power that is too high and therefore are likely to provide inferior storage stability, color reproducibility, carrier liquid separation, and recording medium contamination. In contrast, the isoparaffinic ones show the most ideal dissolving properties among these solvents, and therefore the isoparaffinic hydrocarbons are particularly preferable in this respect also.

The carrier liquid (C) preferably has a kauri-butanol value (KB value: ASTM D1133) of 40 or lower, more preferably within the range of 20 to 30. Its aniline point (JIS K2256) is preferably within the range of 60 to 105° C., more preferably within the range of 70 to 95° C. If the kauri-butanol value is no higher than 40 or the aniline point is no lower than 60° C., the carrier liquid will not dissolve the toner particles or the colorant (B), leading to the preferable results including the improvement of storage stability and color reproducibility, suitable progression of the carrier liquid separation from the binder resin (A) during the drying, and prevention of such problems as recording medium contamination caused by color transfer to the carrier liquid. The aniline point of no higher than 105° C. is preferable because the suitable affinity between the toner particles and the carrier liquid (C) before the drying can be thereby obtained, and furthermore, higher compatibility with the dispersing agent (D) etc. can be obtained (if the dispersing agent (D) etc. are used at all as described below), resulting in the improvement of the dispersibility and the betterment of the image density.

The non-aromatic hydrocarbon used as a carrier liquid (C) may be synthesized by any known methods of polymerization, or it may be purchased from commercial suppliers. Examples of the commercially available products that can be used as the carrier liquid (C) include, referring to the tradenames: mixtures of branched paraffin solvents such as “Shellsol® TM” (product of Shell Chemicals), “IP Solvent® 2028, 2835” (Idemitsu Kosan), and “Isoper® M, L” (Exxon Mobil Corporation); and naphthenic hydrocarbons such as “Exxsol® D40, D80, D110, D130” (Exxon Mobil Corporation), and “AF solvent No. 4, No. 5” (JX Nippon Oil & Energy Corporation).

A single type of the carrier liquid (C) may be used alone or two or more types may be used in combination. If two or more types are used in combination, the liquid developer in which the multiple types of non-aromatic hydrocarbons have been mixed may be produced in advance, or the non-aromatic hydrocarbons may be mixed within the printer apparatus. In the latter case, it is preferable to provide a mechanism to measure the constitutions of the carrier liquids in the mixture as needed, e.g. in-line, based on the viscosity, specific gravity, or the like so that the mix ratio is maintained within a suitable range.

When two or more solvents are mixed, the solvents preferably are similar to each other in their chemical structures. In the interest of anti-oxidative and dissolving properties described above, each of the solvents mixed is preferably an isoparaffinic hydrocarbon. For the same reasons, the proportion of the isoparaffinic hydrocarbons is preferably 50% by mass or higher of the total amount of the carrier liquid(s) when two or more types of carrier liquids (C) are used in combination or when a mixture of multiple compounds is used. This proportion is more preferably 70% by mass or higher, still more preferably 90% by mass or higher, and especially preferably 95% by mass or higher.

The dielectric constant of the carrier liquid (C) is preferably 10 or lower, more preferably within the range of 1 to 5, and especially preferably within the range of 2 to 3. The electrical resistivity of the carrier liquid (C) is preferably 10⁹ Ω·cm or higher, more preferably 10¹⁰ Ω·cm or higher, and especially preferably within the range of 10¹¹ to 10¹⁶ Ω·cm. The electrical resistivity can be measured by the combination of the universal electrometer MMA-II-17D manufactured by Kawaguchi Electric Works and the LP-05 electrode for liquid. When the electrical resistivity of the carrier liquid (C) is 10⁹ Ω·cm or higher, the chargeability of the toner particles becomes higher, resulting in satisfactory image density and improvement of color reproducibility and coloring property.

### (Dispersing Agent (D))

The dispersing agent (D) may be added in the carrier liquid (C) to evenly disperse the toner particles, and has the effect of further improving the developing properties. When the dispersing agent is added in the carrier liquid (C) to disperse the toner particles, the dispersing agent is presumably adsorbed to the binder resin (A) part of the toner particle surface. Any substance that can stably disperse the toner can be used as the dispersing agent, which can be synthesized by any known methods or purchased from commercial suppliers. Specific examples include surfactants, polymeric dispersing agents, and the likes. Polymeric dispersing agents having at least one, or more, structures selected from the group consisting of alkyl group with carbon number of 9 to 24, aromatic amino group, aliphatic amino group, nitrogen-containing heterocyclic group, oxygen-containing heterocyclic group, sulfur-containing heterocyclic group, and pyrrolidone group are preferable among others. Examples of the commercially available ones include “Antaron V-216”, “Antaron V-220” (both tradenames; products of GAF/ISP Chemicals), “Solsperse 13940”, “Lubrizol 2153” (both tradenames; products of Lubrizol Corporation), and the likes.

Besides the ones mentioned above, those conventionally used as dispersing agents in the liquid developers may also be used. Specific examples include aliphatic acid metal salts such as cobalt naphthenate, zinc naphthenate, copper naphthenate, manganese naphthenate, cobalt octoate, and zirconium octoate, lecithin, titanate coupling agents of organic titanates such as titanium chelates, alkoxy titanium polymers, polyhydroxytitanium carboxylate compounds, titanium alkoxides, succinimide compounds, polyimine compounds, fluorine-containing silane compounds, pyrrolidone compounds, and the likes. Titanium alkoxides, succinimide compounds, fluorine-containing silane compounds, pyrrolidone compounds and the likes are preferable among others.

The amount of the dispersing agent (D) added to 100 parts by mass of the toner particles is preferably 0.5 to 10 parts by mass, more preferably 1 to 8 parts by mass. The amount of no lower than 0.5 parts by mass is preferable because the dispersibility and pulverization of the toner particles as well as the storage stability will improve. The amount of no higher than 10 parts by mass is preferable because the charging property of the toner particles can be maintained within a suitable range and the image density and the fixability can be thereby improved. Further, with the amount of the dispersing agent (D) within the above range, the toner particles adsorbing the dispersing agent (D) will not have excessive affinity to the low volatility components of the carrier liquid (C), thereby suitably facilitating the carrier liquid separation. Suitable volatility of the carrier liquid (C) can be thereby achieved, facilitating the improvement of the anti-cold-offset property and fixability in the fixing process as well as the betterment of the image quality. It should be noted that when the dispersing agent (D) is comprised in the toner particles, the above-mentioned ranges for the added amount refer to the ranges including the amount of the dispersing agent (D) comprised within the toner particles.

### (Other Additives)

### (Pigment Dispersant)

In the liquid developer of the present embodiment, a pigment dispersant may be added internally in the toner particles for the purpose of improving the dispersibility of the colorant (B) within the toner particles. Examples of the pigment dispersants that may be internally added to the toner particles include polyamine-based resin type dispersing agents Solsperse 24000SC, 32000, 33000, 35000, 39000, 76400, 76500 (products of Lubrizol Corporation), Ajisper PB821, PB822 (products of Ajinomoto Fine-Techno); acryl copolymer resin type dispersing agent BYK-116 (product of BYK-Chemie), and the likes. In particular, when the liquid developer is manufactured via a colored masterbatch having a high pigment concentration, it is preferable to add the pigment dispersant during the production of the masterbatch. The amount of the pigment dispersant added to 100 parts by mass of the colorant (B) is preferably no less than 3 parts by mass, more preferably no less than 5 parts by mass, in the interest of improving dispersibility of the colorant (B) in the toner particles. The amount of the pigment dispersant added to 100 parts by mass of the colorant (B) is preferably no higher than 40 parts by mass, more preferably no higher than 30 parts by mass, in the interest of improving the pulverization of the toner particles and production efficiency.

### (Release Agent)

Generally, the release agents seep out to, or form unevenness on, the surface of the deposited layer during the fixing process to provide a release effect. There are no particular limitations to the release agents used in the present invention and any known release agents can be used. The examples include hydrocarbon-based wax (polyolefin wax such as polyethylene wax, polypropylene wax, and polybutene wax, and long chain hydrocarbon wax such as paraffin wax, microcrystalline wax, and sasol wax) and derivative thereof, polyester wax and derivative thereof, and polyamide wax and derivative thereof. Among these, hydrocarbon-based wax is preferable, especially polyolefin wax, due to the excellent anti-offset property and fixability it provides. A single type of these materials may be used alone or two or more types may be used in combination.

If a commercially available release agent is to be used, examples of the polyolefin wax that may be suitably used include Polywax 500, 1000, 2080P (products of Toyo ADL), Sanwax 131P, Sanwax 161P (products of Sanyo Chemical Industries), Hi-Wax 800P, Hi-Wax 720P, Hi-Wax 400P, Hi-Wax 320MP, Hi-Wax NP055, Hi-Wax NP105 (products of Mitsui Chemicals), and the likes.

The melting point of the release agent is preferably within the range of 50 to 160° C., more preferably 60 to 140° C., and still more preferably 80 to 130° C. With the melting point of no lower than 50° C., good anti-heat storability can be obtained. The melting point of no higher than 160° C. is preferable because cold-offset can be suppressed during the fixing at low temperatures.

When a release agent is used, its total amount is preferably within the range of 1 to 40 parts by mass, more preferably 2 to 30 parts by mass, still more preferably 3 to 10 parts by mass, relative to 100 parts by mass of the toner particles. With the amount of the release agent kept within this range, suitable anti-offset properties and fixability of the liquid developer can be obtained.

### (Pigment Derivative)

It is also possible to add a pigment derivative to the toner particles, to the extent that it does not impair the coloring property of the colorant (B). Specific examples include the compounds in which one or more groups selected from basic substitution group, acidic substitution group, or phthalimide methyl group, which may itself have a substitution group, are introduced to a base structure selected from organic pigment, organic dye, anthraquinone, acridone, or triazine. Those having organic pigments as the base structures are preferable among others. A single type of these pigment derivatives may be used alone, or two or more types may be used in combination.

Further specific examples include those described by e.g. JP S63-305173 A, JP S57-15620 B, JP S59-40172 B, JP S63-17102 B, and JP H05-9469 B.

When a pigment derivative is used, its amount added to 100 parts by mass of the colorant (B) is preferably no less than 0.5 parts by mass, more preferably no less than 1 parts by mass in the interest of improving dispersibility. Its amount added to 100 parts by mass of the colorant is preferably no higher than 4 parts by mass, more preferably no higher than 2 parts by mass, in the interest of heat resistance and light resistance. If the pigment derivative is introduced at 0.5 to 4 parts by mass to the colorant (B), not only the dispersion stability of the toner particles as mentioned above but also the stable maintenance of the toner particle charge polarity can be facilitated.

### (Charge Controlling Agent)

The liquid developer of the present embodiment may comprise a colorless or pale color charge controlling agent as needed, to the extent that it does not interfere with the hue. The charge controlling agent may be a positive or negative charge controlling agent depending on the polarity of the electrostatic image to be developed on the electrostatic latent image-holding structure. The liquid developer of the present embodiment preferably has the toner particles bearing positive charge, and therefore a positive charge controlling agent is preferable. A single type of charge controlling agent may be used alone or two or more types may be used in combination.

Examples of the positive charge controlling agents include quaternary ammonium salt compounds (for example, tributylbenzylammonium-1-hydroxy-4-naphthosulfonic acid salt and tetrabutylbenzylammonium tetrafluoro borate), quaternary ammonium salt organic tin oxide (for example, dibutyltin oxide, dioctyltin oxide, and dicyclohexyltin oxide), diorganotin borate (for example, dibutyltin borate, dioctyltin borate, and dicyclohexyltin borate), and the likes. The triarylmethane-based pigments may also be used as a positive charge controlling agent. These charge controlling agents may be present with the colorant (B) etc. within the toner particles, or they may be present in the carrier liquid (C) separate from the toner particles.

Instead of the above-mentioned charge controlling agents, resin-based charge controlling agents may also be used. Examples of the resin-based charge controlling agents for positive charge include those comprising the structure represented by General Formula (2) shown below. In General Formula (2), the polymerization mode of each structural unit may be block or random, and in the case of block, the positions of the structural units may vary from the positions shown.

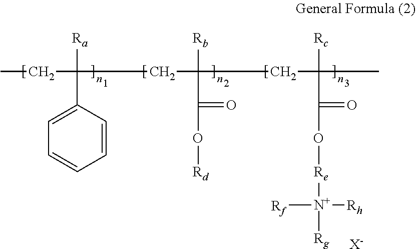

In General Formula (2), Rₐ, R_{b}, and R_{c} each represent a hydrogen atom or methyl group, and R_{d} represents an alkyl group of a carbon number of 1 to 8 which may be branched. Rₑ represents an alkylene group of a carbon number of 1 to 8 which may be branched, preferably an ethylene group. R_{f}, R_{g}, and Rₕ each represent a hydrogen atom, methyl group, or ethyl group, preferably a methyl or ethyl group. n₁, n₂, and n₃ each represent an integer of 1 or greater, wherein 100×n₃/(n₁+n₂+n₃) is preferably 3 to 35. X⁻ represents a monovalent anion, preferably a halogen ion, or an alkylcarboxylate, alkylsulfonate, or tosyl ion.

Specific examples of the resins represented by General Formula (2) include butyl acrylate/N,N-diethyl-N-methyl-2-(methacryloyloxy)ethyl ammonium=tosylate/styrene copolymers. These are colorless and transparent and therefore suitable for use in the color toners. These resin-based charge controlling agents may be present with the colorant (B) etc. within the toner particles, or cover the toner particle surfaces, or be present in the carrier liquid (C) separate from the toner particles.

When the charge controlling agent is added, it is usually preferable to add 1.0 to 20.0 parts by mass, more preferably 2.0 to 8.0 parts by mass, relative to 100 parts by mass of the binder resin (A).

### (Production Method)

The method for obtaining the toner for the liquid developer of the present embodiment may be selected from any of the conventionally used methods such as melt kneading, suspension polymerization, emulsion polymerization, and solution deposition. The melt kneading method is preferable from the viewpoints of production efficiency and environmental impact, and the compatibility with the wet grinding described below. It is preferable to use a wet grinder (disperser) apparatus loaded with dispersion media to disperse the toner particles, especially the toner particles obtained through melt kneading, in the carrier liquid (C). With the use of the grinder apparatus, the toner particle surface can be evenly and completely wetted by the physical force, realizing the uniform affinity with the low volatility components in the drying process as well as uniform energy transfer through the remaining carrier liquid components in the fixing process, hence good image quality, anti-cold-offset property, and fixability with the liquid developer. Further, the use of the wet grinder is preferable because it facilitates the production of disc shaped toner particles, which can more efficiently propagate the thermal energy in the fixing process compared to the more globular toner particles produced by the suspension polymerization method, emulsion polymerization method, solution deposition method, or the likes.

Described below is an example of producing a liquid developer of the present embodiment which uses the melt kneading method and disperses the toner particles by using a wet grinder.

### (1) Preparation of a Colored Masterbatch for Toner Particles

Binder resin (A) and colorant (B) are kneaded by using a twin screw extruder, heating rollers, or the like at such proportions that the concentration of the colorant (B) in the masterbatch will be 10 to 60 parts by mass. After cooling, crude grinding is performed to obtain a colored masterbatch. In addition to the binder resin (A) and the colorant (B), pigment dispersant, charge controlling agent, pigment derivative, releasing agent etc. may be added.

### (2) Preparation of Toner Particle Chips (Dilution of Colored Masterbatch)

The colored masterbatch obtained in step (1) and a binder resin (A) are mixed and pre-dispersed in a mixer such as a super mixer. In the subsequent melt kneading, the toner particle chips are obtained in which the colored masterbatch is diluted and distributed into the binder resin (A). Dispersing agent (D), pigment dispersant, charge controlling agent, releasing agent etc. may be added during the pre-dispersing and the melt kneading here. It is further preferable to crude grind the toner particle chips to the particle size of 10 mm of smaller by hammer mill, sample mill or the like. It is also possible to integrate steps (1) and (2), and in that case, all the materials may be added during the pre-dispersing in step (2) to prepare the toner particle chips without undergoing the colored masterbatch step (1). For melt kneading, any known kneading apparatus may be used such as pressure kneader, Banbury mixer, and single screw and twin screw extruders. It is further preferable to grind the toner particle chips to the particle size of 5 mm of smaller. The grinding may be carried out by any conventional/known methods, but a preferable method is to crude-grind by a hammer mill, sample mill or the like followed by fine-grinding by a jet air stream grinder such as jet mill, or a mechanical grinder such as turbo mill.

### (3) Wet Grinding of Toner Particles

The dry ground toner particles obtained in step (2) are distributed into a solvent having the same composition as the carrier liquid (C), and wet grinding is carried out by using a wet grinder such that the average particle size will be within the range of 0.5 to 4 μm, more preferably 1 to 3 μm. Addition of a dispersing agent (D) (which functions by being adsorbed to the toner particles) at this step is also effective. The dispersing agent will be adsorbed to the toner particles through the wet grinding and dispersing step, stabilizing the toner particles in terms of electric charge as well. During the wet grinding (dispersing), the materials are preferably cooled such that the grinding temperature does not exceed 50° C. If the temperature is no higher than 50° C., the particle size distribution can be controlled without causing the fusion of the toner particles.

Examples of the wet grinder apparatus that may be used for wet grinding the toner particles include the mills that employ grinding media, such as the moving vessel grinding media mills and the stirred media type mills. The stirred media type mills are preferable among others due to their production efficiency, grinding capacity, and ease of controlling the particle size distribution. Especially, the wet grinder apparatuses in the class of horizontal grinder chamber type mills are preferable, specific examples of which include the Dyno-Mill of Shinmaru Enterprises Corporation.

The factors that determine the grinding efficiency in the wet grinder include the types and the sizes of the grinding media, the charge rate of the dispersing media inside the grinder apparatus, the concentration of the sample to be ground in the liquid, the viscosity, and the types of the suspending solvents. The types and the sizes of the grinding media have especially large impact.

For the grinding media, glass beads, zircon beads, zirconia beads, alumina, titania or the like may be used depending on, e.g., the viscosity and specific gravity of the toner particles and the required particle size in the grinding and dispersing. Zirconia beads or zircon beads are preferable among others in order to obtain good grinding efficiency. The diameter of the grinding media is preferably within the range of 0.1 to 3.0 mm, especially within the range of 0.3 to 1.4 mm. With the diameter of the grinding media being no smaller than 0.1 mm, the stress inside the grinder apparatus can be reduced, which can prevent the reduction of the grinding efficiency caused by thermal melting of the toner particles. With the diameter of the grinding media being no larger than 3.0 mm, sufficient grinding can be carried out.

The charge rate of the dispersing media inside the grinder apparatus is preferably within the range of 40 to 85% by mass. With the charge rate being no higher than 85% by mass, the stress inside the grinder apparatus can be reduced, thereby the difficulty of grinding caused by thermal melting of the toner particles can be avoided. With the charge rate of no lower than 40% by mass, fine-grinding is facilitated due to the improvement of the grinding efficiency. When the concentration of the toner particles in the slurry is high (40 to 50% by mass), the charge rate is preferably 40 to 70% by mass.

### (4) Preparation of Liquid Developer

To the material obtained in step (3), comprising the wet-ground toner particles (comprising at least binder resin (A) and colorant (B)) and carrier liquid (C), a further amount of carrier liquid (C) as well as dispersing agent (D) as needed is added, and following the mixing and the adjustment of the toner particle concentration, a liquid developer is prepared.

### (Physical Properties of the Liquid Developer)

The toner particles in the liquid developer preferably have an average particle size (D50) of 0.5 to 4 μm, more preferably 1 to 3 μm. The particle sizes in the present invention can be measured by using the laser diffraction/scattering particle size analyzer Microtrac HRA manufactured by Nikkiso, and the average particle size (D50) is the diameter at the cumulative 50%.

From the view point of the development property in relation to coloration, the total toner particles preferably comprise no more than 50% by volume of the toner particles having a particle size of 2 μm or smaller, 5 to 60% by volume of the toner particles having a particle size of 1 to 3 μm, and no more than 35% by volume of the toner particles having a particle size of 5 μm or larger. When the toner particles having a particle size of 2 μm or smaller is no more than 50% by volume, higher adsorption of the dispersing agent (D) to the toner particles can be obtained, resulting in good storage stability. When the toner particles having a particle size of 5 μm or larger is no more than 35% by volume, the effects obtained will include the higher image density and the improvement of color expression and color reproducibility. The inclusion of 5 to 60% by volume of the toner particles having a diameter of 1 to 3 μm is preferable for the dispersion stability of the toner particles and the excellent storage stability for the long-term.

The concentration of the toner particles in the liquid developer is preferably within the range of 10 to 30% by mass relative to 100% by mass of the liquid developer. The range is more preferably 12 to 25% by mass. With the concentration of no lower than 10% by mass, the removal of the carrier liquid (C) will be easier, improving the fixability of the toner particles. With the concentration of no higher than 30% by mass, the viscosity of the liquid developer is kept low, which improves the mobility of the toner particles and results in a sufficient image density. Further, the storage stability becomes higher because the agglomeration of the toner particles becomes weaker.

The polymeric dispersing agent adsorption rate (hereinafter simply referred to as adsorption rate) of the dispersing agent (D) to the toner particles in the liquid developer is preferably 50% or higher, more preferably 70% or higher. With the adsorption rate of 50% or higher, higher dispersion stability of the toner particles can be obtained, thus the average particle size and the viscosity of the liquid developer would not rise even in the long-term storage, and thus stable color expression and color reproducibility can be obtained. The adsorption rate is defined as (the amount of the dispersing agent adsorbed to the toner particles)/(the amount of the dispersing agent contained in the liquid developer), and can be measured for example as follows: 10 g of the liquid developer is weighed out, and centrifuged at 19,000 rpm for 20 minutes in Hitachi Koki Centrifuge CR22H. One gram of the separated supernatant solution is then weighed out and the carrier liquid (C) is allowed to evaporate over 1 hour in an oven at 160° C. The remaining dispersing agent (D) is weighed, and the obtained value is used to calculate the adsorption rate to the toner particles.

### (Drying/Fixing Process)

When the liquid developer of the present embodiment is used for printing, the recording medium receiving the liquid developer preferably undergoes a drying process and a fixing process. These processes may be carried out either simultaneously or separately, but the latter is preferred for the liquid developer of the present embodiment. In the latter case, the heating process is preferably carried out first.

The drying process in the printing using the liquid developer of the present embodiment is, as described above, to dry the high volatility components of the carrier liquid (C), and it can use any drying methods. Examples include contact drying methods involving heating rollers, drums, conveyers and the likes, air flow drying methods such as those involving heated air, and electromagnetic wave drying methods such as those involving infrared, ultraviolet, visible light and microwave. The non-contact methods such as air flow drying methods and electromagnetic wave drying methods are preferable, and the electromagnetic wave drying methods using at least one selected from infrared, visible light or microwave are especially preferable. This is because in these methods, even in a condition where much of the carrier liquid remains, the temperature drop of the drying apparatus associated with the heat of vaporization during the drying of the carrier liquid does not occur, and therefore high quality images can be continuously and stably obtained. Any single type of the above-mentioned drying methods may be chosen, or two or more types may be combined.

The fixing process in the printing using the liquid developer of the present embodiment is to fix the toner particles onto the recording medium and also to dry the residual low volatility components of the carrier liquid (C), and it can use any conventionally known methods. Examples include heat pressure methods using rollers, drums, conveyers, films or the likes, pressure methods using pressurizing rollers or the likes, the heat methods using those described above for the drying process, and the methods using fixing solutions. Any single type of the above-mentioned methods may be chosen, or two or more types may be combined. If the fixing process is to be carried out simultaneously with the drying process described above, it is preferable to choose a non-contact drying method such as the air flow drying method and the electromagnetic wave drying method.

### (Liquid Developer Set)

The liquid developer of the present embodiment may be used in a single color, or plurality of the liquid developers having different colors may be prepared to provide a liquid developer set. For example, the four basic process colors, namely yellow, magenta, cyan, and black, can be used in a liquid developer set to obtain full-color images, and by further adding special colors such as violet, green, and orange, the color ranges of the images can become superior.

Further, a white liquid developer can be used in combination with color liquid developers. The printing methods in that case can include the following examples, any of which may be suitably employed: a method in which the white liquid developer only is first transferred/fixed onto the print recording medium to render solid printing and then the color liquid developers are used on the solid printing surface to print the image; a method in which the color liquid developers only are first transferred/fixed onto the print recording medium to print the image and then the white liquid developer is used on the surface of the printed image to render solid printing; and a method in which the white liquid developer and the color liquid developers are simultaneously or sequentially transferred onto the print recording medium and then fixed together to form the image. When the white liquid developer and the color liquid developers are simultaneously or sequentially transferred onto the print recording medium, any color sequence in the printing can be chosen at will. For example, the white liquid developer of the present invention may be first transferred onto the print recording medium to use it like a pre-treatment liquid for the color liquid developers.

### (Recording Medium)

There is no particular limitation to the recording medium used for the printing with the liquid developer, and commonly used papers such as woodfree paper, coated paper, PET sheet, and PP sheet are suitably used. These print recording media may have smooth or uneven surfaces and may be transparent, semi-transparent, or opaque. The print recording medium may comprise two or more types of these media layered on each other. Further, a peelable sticky layer or the like may be provided on the face opposite the printed face, or a sticky layer or the like may be provided on the printed face following the printing.

The coated paper may be any of the diverse coated papers conventionally used for various purposes. Specific examples include low coat weight paper, lightweight coated paper, coated paper, art paper, matte coated paper, and cast coated paper, and there is no limitation to their thicknesses and shapes. The coated papers are especially preferable because they can produce good image quality and are capable of printing sharp characters and barcodes when used with the liquid developer of the present embodiment.

### (Applications of the Printed Materials)

The printed materials printed with the liquid developer may be used for e.g. general commercial purpose, paper package, wrapping film, sealing, and labeling applications. For example, the general commercial applications may include books and ledgers such as catalogs and magazines using woodfree papers, coated papers and the likes; the paper packages may include package containers and outer boxes using coated papers, cardboards and the likes; and the wrapping films may include soft package containers using PET sheets, PP sheets and the likes.

### EXAMPLES

Below the present invention will be described in further details by representative examples, but the embodiments of the present invention are not limited to these examples. Unless otherwise indicated, “parts” refers to “parts by mass”.

### (Synthesis Example for Binder Resin 1)

The polyalcohols and the polycarboxylic acids shown in Table 1 and two parts of dibutyltin oxide as a catalyst were added to a flask equipped with reflux condenser, fractionating column, nitrogen gas inlet tube, thermometer, and stirrer, and heated to 200° C. while the mixture was stirred and nitrogen gas was introduced. After the temperature inside the vessel reached 200° C., the reaction was continued for 4 hours while the reaction temperature was maintained. The pressure was then reduced, and the reaction was further continued for 1 hour under the reduced pressure. The normal pressure was then recovered and the reaction temperature was lowered to 100° C. or lower to stop the condensation polymerization and to obtain Binder Resin 1 which was a polyester resin.

TABLE 1

| Components | Binder Resin 1 | |
|---|---|---|
| Bisphenol A propylene oxide adduct | 400 | parts |
| Bisphenol A ethylene oxide adduct | 200 | parts |
| Terephthalic acid | 270 | parts |
| Trimellitic acid | 50 | parts |

In Table 1, the bisphenol A propylene oxide adduct refers to a compound of General Formula (1) wherein R is a propylene group and x=y=2. The bisphenol A ethylene oxide adduct refers to a compound of General Formula (1) wherein R is an ethylene group and x=y=2.

### (Synthesis Examples for Binder Resins 2 and 3)

Binder Resin 1 obtained above was added to an equal amount of toluene, heated and dissolved. This solution was stirred and heated to the boiling point of toluene while introducing the nitrogen gas. After the temperature inside the vessel reached the boiling point of toluene, a mix solution comprising the styrene-based monomers and the (meth)acryl-based monomers shown in Table 2 and di-t-butylperoxide as a polymerization initiator was added dropwise over 2 hours to carry out solution polymerization. After the completion of the dropwise addition, the reaction was continued for 2 hours at the boiling temperature of toluene, another 1 part of di-t-butylperoxide was then added to consume the unreacted monomers, and the polymerization was then stopped. The temperature was then raised to 180° C. to remove the toluene, and Binder Resins 2 and 3 comprising the polyester resin and the styrene-(meth)acryl copolymer resin were obtained.

### (Synthesis Examples for Binder Resins 4 and 5)

Toluene was added to a flask, stirred and heated to the boiling point of toluene while introducing the nitrogen gas. After the temperature inside the vessel reached the boiling point of toluene, a mix solution comprising the styrene-based monomers and the (meth)acryl-based monomers shown in Table 2 and di-t-butylperoxide as a polymerization initiator was added dropwise over 2 hours to carry out solution polymerization. After the completion of the dropwise addition, the reaction was continued for 2 hours at the boiling temperature of toluene, another 1 part of di-t-butylperoxide was then added to consume the unreacted monomers, and the polymerization was then stopped. The temperature was then raised to 180° C. to remove the toluene, and Binder Resins 4 and 5, which were styrene-(meth)acryl copolymer resins, were obtained.

TABLE 2

| Components | Binder Resin 2 | | Binder Resin 3 | | Binder Resin 4 | | Binder Resin 5 | |
|---|---|---|---|---|---|---|---|---|
| Binder Resin 1 | 800 | parts | 800 | parts | | | | |
| Styrene | 130 | parts | 130 | parts | 497 | parts | 497 | parts |
| Acrylic acid | 17 | parts | 17 | parts | 30 | parts | 60 | parts |
| 2-Ethylhexyl acrylate | 45 | parts | 5 | parts | | | | |
| n-Butyl acrylate | 5 | parts | | | | | | |
| Benzyl acrylate | | | 40 | parts | | | | |
| Ethyl methacrylate | | | | | 200 | parts | 200 | parts |
| Methoxy diethylene | | | | | 270 | parts | 240 | parts |
| glycol methacrylate | | | | | | | | |
| Di-t-butylperoxide | 3 | parts | 3 | parts | 3 | parts | 3 | parts |

### (Synthesis Examples for Binder Resins 6 and 7)

The same synthesis was carried out as for Binder Resin 1, except that the materials, amounts, and the reaction conditions shown in Table 3 were used, to obtain Binder Resins 6 and 7.

TABLE 3

| Components/Reaction Conditions | Binder Resin 6 | | Binder Resin 7 | |
|---|---|---|---|---|
| Bisphenol A propylene oxide adduct | 290 | parts | | |
| Bisphenol A ethylene oxide adduct | 290 | parts | | |
| Propylene glycol | | | 190 | parts |
| Terephthalic acid | 110 | parts | 575 | parts |
| Fumaric acid | 170 | parts | | |
| Trimellitic acid | | | 435 | parts |
| Reaction temperature | 210° | C. | 180° | C. |
| Reaction time | 2 | hours | 1.5 | hours |

The physical properties of Binder Resins 1 to 7 obtained above are shown in Table 4. The values shown in Table 4, except the glass-transition temperatures, were measured as described above. The glass-transition temperatures were measured by the method described below.

TABLE 4

| | | Glass- | | | Weight |
|---|---|---|---|---|---|
| | | transition | Softening | | average |
| | Acid value | temperature | temperature | | molecular |
| | (mgKOH/g) | (Tg) | (T4) | | weight (Mw) |
| Binder Resin 1 | 26 | 52 | 112° | C. | 11000 |
| Binder Resin 2 | 33 | 56 | 125° | C. | 12800 |
| Binder Resin 3 | 34 | 52 | 110° | C. | 11700 |
| Binder Resin 4 | 23 | 50 | 95° | C. | 25000 |
| Binder Resin 5 | 46 | 53 | 98° | C. | 23000 |
| Binder Resin 6 | 6 | 48 | 82° | C. | 2200 |
| Binder Resin 7 | 45 | 50 | 95° | C. | 3000 |

### (Measurement of Glass-Transition Temperature)

The measurements were made according to the method provided by ASTM D3418-82. Specifically, 10 mg of the binder resin sample was placed on a platinum pan, and the measurements were made by using “Differential Scanning calorimeter DSC-60PLUS” of Shimadzu Corporation under the following conditions: initial temperature 25° C.; final temperature 150° C.; heating rate 10° C./minute. An empty platinum pan was used as a reference.

### (Colorant)

The materials shown in Table 5 were used as colorants.

TABLE 5

| Color | C.I. Number/Pigment Type | Product Name | Manufacturer |
|---|---|---|---|
| Cyan | Pigment blue 15:3 | Lionol Blue | Toyocolor |
| | (Copper phthalocyanine blue) | FG 7919 | |
| Magenta | Pigment red 122 | Hostaperm | Clariant |
| | (Quinacridone magenta) | Pink E | |
| | Pigment red 57:1 | Permanent | Clariant |
| | (Carmine 6B) | Rubine L6B | |
| Yellow | Pigment yellow 180 | Novoperm | Clariant |
| | (Benzimidazolone yellow) | Yellow P-HG | |
| Black | Carbon black | NIPEX150 | Degussa |
| White | Titanium oxide | Tipaque PF-740 | Ishihara Sangyo |
| | | | Kaisha |

### (Release Agent)

Polywax 2080P (product of Toyo ADL) was used as a release agent.

### (Dispersing Agent)

Antaron V-216 (product of ISP Chemical; hereinafter referred to as V-216) was used as a dispersing agent.

### (Pigment Dispersant)

Solsperse 24000SC (product of Lubrizol Japan; basic resin type dispersing agent (polyamine-based resin); acid value 25mgKOH/g) was used as a pigment dispersant.

### (Carrier Liquid)

The materials or mixtures shown in Table 6 were used as carrier liquids. Table 6 also shows initial boiling points, dry points, and the differences between the dry points and the initial boiling points as measured by the methods described above.

TABLE 6

| | | | | | Carrier liquid a/ | Initial boiling | Dry | Difference between dry point |
|---|---|---|---|---|---|---|---|---|
| | Carrier liquid a | | Carrier liquid b | | Carrier liquid b | point | point | and initial boiling point |
| | Product name | Type | Product name | Type | weight ratio | [° C.] | [° C.] | [° C.] |
| Carrier liquid 1 | IP Solvent | Isoparaffin | IP Solvent | Isoparaffin | 9/1 | 213 | 353 | 140 |
| | 2028 | | 2835 | | | | | |
| Carrier liquid 2 | Isoper M | Isoparaffin | IP Solvent | Isoparaffin | 8/2 | 224 | 353 | 129 |
| | | | 2835 | | | | | |
| Carrier liquid 3 | Shellsol TM | Isoparaffin | IP Solvent | Isoparaffin | 5/5 | 215 | 354 | 139 |
| | | | 2835 | | | | | |
| Carrier liquid 4 | NA Solvent-4 | Isoparaffin | NA Solvent-5 | Isoparaffin | 7/3 | 210 | 340 | 130 |
| Carrier liquid 5 | Isoper H | Isoparaffin | Isoper V | Isoparaffin | 5/5 | 184 | 311 | 127 |
| Carrier liquid 6 | IP Solvent | Isoparaffin | | | 10/0 | 277 | 353 | 76 |
| | 2835 | | | | | | | |
| Carrier liquid 7 | Isoper M | Isoparaffin | | | 10/0 | 213 | 262 | 49 |

### Example 1

### (Preparation of Cyan Ground Powder 1)

| | |
|---|---|
| C.I. Pigment blue 15:3 | 18 parts by mass |
| Binder Resin 1 | 79 parts by mass |
| Polywax 2080P | 3 parts by mass |

The above materials (total 5 kg) were mixed in a 20 L volume Henschel mixer (3,000 rpm, 3 minutes) and then melt kneading was performed by using the twin screw extruder (PCM30) at 6 kg/hr feeding and 145° C. extrusion temperature. Further kneading was then performed by 3 rolls at a roll temperature of 140° C. The kneaded product was cooled and solidified, crude-ground by a hammer mill, and then fine-ground by a type I jet mill (IDS-2) to obtain Cyan Ground Powder 1 having an average particle size of 5.0 μm.

### (Production of Liquid Developer 1C)

Further, the following materials were weighed out, stirred and mixed well, and wet-ground by 60 minute cycle operation of a stirred media type mill, Dyno-Mill Multi Lab (Shinmaru Enterprises Corporation; 1.4 L volume).

| | |
|---|---|
| Cyan Ground Powder 1 | 25 parts by mass |
| Carrier Liquid 1 | 74 parts by mass |
| Antaron V-216 | 1 part by mass |

The conditions for the wet-grinding were as follows: agitator disc (material: zirconia); cycle speed 10 m/s; cylinder ZTA; media (material: zirconia) diameter 1.25 mm; charge rate 70%; solution flow rate 45 kg/h; coolant water 5 L/min; pressure 0.1 Kg/cm². After the completion of the wet-grinding, the slurry was taken out and passed through a mesh having the openings of 33 μm (made of SUS304) to obtain Liquid Developer 1C having an average particle size (D50) of 2.5 μm and viscosity (η) of 50 mPa·s.

The average particle size mentioned above was a value measured by using the laser diffraction/scattering particle size analyzer Microtrac HRA manufactured by Nikkiso. Specifically, Exxsol D80 (Exxsol TM) (product of Exxon Mobil Corporation) was used as a solvent, and the measurement was made under the ambient condition of 23° C. and 50% RH. The viscosity (η) was measured by using the type E viscometer TV-22 manufactured by Toki Sangyo. Specifically, the solid fraction in the liquid developer was adjusted to 25% and conditioned well at 25° C., and a 1°34′ cone was set in the viscometer TV-22, and the value was read after 1 minute at 10 rpm.

### Examples 2-7, Comparative Examples 1-6, Comparative Examples 8-10

Toner ground powders were prepared by using the materials shown in Table 7 and the same method as described for Cyan Ground Powder 1. Subsequently, liquid developers were prepared by using the toner ground powders, dispersing agents, and carrier liquids shown in Table 8 and the same method as described for Liquid Developer 1C.

### Comparative Example 7

To 25 parts of Cyan Ground Powder 1, 85 parts of methyl ethyl ketone was added, and the mixture was heated and stirred at 50° C. to dissolve Cyan Ground Powder 1.

Subsequently, 1 part of V-216 was added and stirred in, and 74 parts of Carrier Liquid 1 which was an insulating solvent was stirred in to dilute and provide a mix solution. Then, by using an apparatus in which a homogenizer comprising a sealed stirring chamber was connected to a solvent distillation apparatus (which was in turn connected to a vacuum apparatus), the mix solution was subjected to high speed stirring by the homogenizer (rotation speed 5000 rpm) as it was heated to 50° C. by the vacuum apparatus. Then, by reducing the pressure to completely remove the methyl ethyl ketone from the sealed stirring chamber, Liquid Developer 37C was obtained.

TABLE 7

| | Cyan | | | | | | | | | |
|---|---|---|---|---|---|---|---|---|---|---|
| | | | | | | | Comparative | Yellow | Magenta | Black |
| | Ground | Ground | Ground | Ground | Comparative | Comparative | Ground | Ground | Ground | Ground |
| | Powder 1 | Powder 2 | Powder 3 | Powder 4 | Ground Powder 1 | Ground Powder 2 | Powder 3 | Powder | Powder | Powder |
| Binder Resin 1 | 79 | | | | | | | 79 | 77 | 76 |
| Binder Resin 2 | | 79 | | | | | | | | |
| Binder Resin 3 | | | 79 | | | | | | | |
| Binder Resin 4 | | | | 79 | | | | | | |
| Binder Resin 5 | | | | | 79 | | | | | |
| Binder Resin 6 | | | | | | 79 | | | | |
| Binder Resin 7 | | | | | | | 79 | | | |
| Polywax 2080P | 3 | 3 | 3 | 3 | 3 | 3 | 3 | 3 | 3 | 3 |
| C.I pigment | 18 | 18 | 18 | 18 | 18 | 18 | 18 | | | 1 |
| blue 15:3 | | | | | | | | | | |
| C.I. pigment | | | | | | | | 18 | | |
| yellow 180 | | | | | | | | | | |
| C.I. pigment | | | | | | | | | 10 | |
| red 122 | | | | | | | | | | |
| C.I. pigment | | | | | | | | | 10 | |
| red 57:1 | | | | | | | | | | |
| Carbon black | | | | | | | | | | 20 |

(In “parts by mass” units)

TABLE 8

| Example/Comparative | | | amount | Dispersing | amount | | amount |
|---|---|---|---|---|---|---|---|
| Example | Liquid Developer Name | Toner Ground Powder | [parts] | Agent | [parts] | Carrier Liquid | [parts] |
| Example 1 | Liquid Developer 1C | Cyan Ground Powder 1 | 25 | V-216 | 1 | Carrier Liquid 1 | 74 |
| Example 2 | Liquid Developer 2C | Cyan Ground Powder 1 | 25 | V-216 | 1 | Carrier Liquid 2 | 74 |
| Example 3 | Liquid Developer 3C | Cyan Ground Powder 1 | 25 | V-216 | 1 | Carrier Liquid 3 | 74 |
| Example 4 | Liquid Developer 4C | Cyan Ground Powder 1 | 25 | V-216 | 1 | Carrier Liquid 4 | 74 |
| Example 5 | Liquid Developer 5C | Cyan Ground Powder 2 | 25 | V-216 | 1 | Carrier Liquid 1 | 74 |
| Example 6 | Liquid Developer 6C | Cyan Ground Powder 3 | 25 | V-216 | 1 | Carrier Liquid 1 | 74 |
| Example 7 | Liquid Developer 7C | Cyan Ground Powder 4 | 25 | V-216 | 1 | Carrier Liquid 1 | 74 |
| Example 8 | Liquid Developer 8C | Cyan Ground Powder 1 | 25 | V-216 | 0.15 | Carrier Liquid 1 | 74.85 |
| Example 9 | Liquid Developer 9C | Cyan Ground Powder 1 | 25 | V-216 | 0.25 | Carrier Liquid 1 | 74.75 |
| Example 10 | Liquid Developer 10C | Cyan Ground Powder 1 | 25 | V-216 | 2 | Carrier Liquid 1 | 73 |
| Example 11 | Liquid Developer 11C | Cyan Ground Powder 1 | 25 | V-216 | 2.5 | Carrier Liquid 1 | 72.5 |
| Example 12 | Liquid Developer 12C | Cyan Ground Powder 1 | 25 | Solsperse | 1 | Carrier Liquid 1 | 74 |
| | | | | 13940 | | | |
| Example 13 | Liquid Developer 22Y | Yellow Ground Powder | 25 | V-216 | 1 | Carrier Liquid 1 | 74 |
| Example 14 | Liquid Developer 23M | Magenta Ground Powder | 25 | V-216 | 1 | Carrier Liquid 1 | 74 |
| Example 15 | Liquid Developer 24K | Black Ground Powder | 25 | V-216 | 1 | Carrier Liquid 1 | 74 |
| Comp. Example 1 | Liquid Developer 31C | Cyan Ground Powder 1 | 25 | V-216 | 1 | Carrier Liquid 5 | 74 |
| Comp. Example 2 | Liquid Developer 32C | Cyan Ground Powder 1 | 25 | V-216 | 1 | Carrier Liquid 6 | 74 |
| Comp. Example 3 | Liquid Developer 33C | Cyan Ground Powder 1 | 25 | V-216 | 1 | Carrier Liquid 7 | 74 |
| Comp. Example 4 | Liquid Developer 34C | Cyan Comparative Ground Powder 1 | 25 | V-216 | 1 | Carrier Liquid 1 | 74 |
| Comp. Example 5 | Liquid Developer 35C | Cyan Comparative Ground Powder 2 | 25 | V-216 | 1 | Carrier Liquid 1 | 74 |
| Comp. Example 6 | Liquid Developer 36C | Cyan Comparative Ground Powder 3 | 25 | V-216 | 1 | Carrier Liquid 1 | 74 |
| Comp. Example 7 | Liquid Developer 37C | Cyan Ground Powder 1 | 25 | V-216 | 1 | Carrier Liquid 1 | 74 |
| Comp. Example 8 | Liquid Developer 38Y | Yellow Ground Powder | 25 | V-216 | 1 | Carrier Liquid 5 | 74 |
| Comp. Example 9 | Liquid Developer 39M | Magenta Ground Powder | 25 | V-216 | 1 | Carrier Liquid 5 | 74 |
| Comp. Example 10 | Liquid Developer 40K | Black Ground Powder | 25 | V-216 | 1 | Carrier Liquid 5 | 74 |

### Examples 1-15, Comparative Examples 1-10

Each of the liquid developers shown in Table 8 above was evaluated as follows. The test results along with the detailed physical properties of the liquid developers are shown in Table 10.

### (Actual Printing Test)

A commercially available liquid developing copier (Savin 870; product of Savin) carrying an amorphous silicon electrostatic latent image-holding structure was used, which had been modified by removing the fixing unit so that the electric potential could be adjusted at will. The electric potential conditions were adjusted as follows: the surface electric potential of the electrostatic latent image-holding structure was +450 to 500V, the residual electric potential was no higher than +50V, and the developing roller bias was +250 to 450V. Under the ambient condition of 23° C./50% RH and at the speed of 30 m/min, images were continuously printed on 1000 sheets of the A4 size Oji Paper OK Topcoat+, wherein the image had mono-color solid printing on the left half of the paper and no printing on the right half. Subsequently, the solid printing on the 500th sheet and the 1000th sheet was heat-fixed by an external fixing apparatus under the condition of 160° C. roller temperature, nip width 6 mm, and 30 m/minute, and these sheets were used for the evaluations described below. Further, the images on the 951st to the 960th sheets were used for the cold-offset property evaluation described below.

### (Image Density)

The density of the image on the 1000th sheet obtained in the actual printing test was measured by X-Rite 504 with a D50 light source, 2° angle of view, and the Status-E condition. The evaluation grades were as indicated in Table 9 below, wherein C or better was considered practically preferable, B or better was more preferable, and A was especially preferable.

TABLE 9

| Evaluation | | | | |
|---|---|---|---|---|
| Grade | Cyan | Yellow | Magenta | Black |
| A | 1.6 or higher | 1.4 or higher | 1.6 or higher | 1.8 or higher |
| B | 1.5 or higher, | 1.3 or higher, | 1.5 or higher, | 1.7 or higher, |
| | lower than 1.6 | lower than 1.4 | lower than 1.6 | lower than 1.8 |
| C | 1.4 or higher, | 1.2 or higher, | 1.4 or higher, | 1.6 or higher, |
| | lower than 1.5 | lower than 1.3 | lower than 1.5 | lower than 1.7 |
| D | lower than 1.4 | lower than 1.2 | lower than 1.4 | lower than 1.6 |

### (Continuous Printing Stability)

For the solid-printed parts of the 500th and the 1000th sheets obtained in the actual printing test, the presence or absence of the white streaks was assessed by visual inspection, wherein the white streaks would have been caused by the adherence of the oxides, generated by the ozone produced from the charging device, to the electrostatic latent image-holding structure etc. The evaluation grades were as shown below, and B or better was considered practically preferable.

A: No streaks present on the image

B: Several streaks present on the image

C: Many streaks present on the image

### (Fixing Rate)

For the solid-printed part of the image on the 1000th sheet obtained in the actual printing test, the image density ID immediately after outputting (ID1) was measured by the same method as described for the image density evaluation. A mending tape (3M Scotch® 810) was then pasted on the solid-printed part, a 1 kg cylindrical brass weight was rolled on it forward and backward, the mending tape was then removed, and the image density (ID2) was measured again. The results were used to calculate 100×ID2/ID1 which was defined as the fixing rate (%). A fixing rate of 80% or higher was considered practically preferable, and 90% or higher was considered especially preferable.

### (Anti-Cold-Offset Property)

For the images on the 951st to the 960th sheets obtained in the actual printing test, heat-fixing was carried out continuously under the condition of 6 mm nip width and 30 m/minute by an external fixing apparatus having a heat-fixing roll provided with a stable temperature. After the output image of the 10th sheet was heat-fixed, the anti-cold-offset property was assessed by checking whether the toner image re-transferred from the heat-fixing roll was present on the 10th output image. This assessment was performed while the temperature of the heat-fixing roll was varied, and the temperatures at which the toner re-transfer did not occur were graded in the four ranks shown below, wherein B or better was considered practically preferable and A was considered especially preferable.

A: Heat-fixing roll temperature of lower than 120° C.

B: Heat-fixing roll temperature of 120° C. to lower than 140° C.

C: Heat-fixing roll temperature of 140° C. to lower than 160° C.

D: Heat-fixing roll temperature of 160° C. or higher

### (ΔL)

For the solid-printed part of the image on the 1000th sheet obtained in the actual printing test, the L value of the non-image part was measured by X-Rite 504 with a D50 light source, 2° angle of view, and the Status-E condition as in the image density evaluation described above. Likewise, the L value of an unprinted paper was measured, and its difference from the L value of the non-image part (ΔL) was calculated to perform the ΔL evaluation. The evaluation grades were as shown below, wherein B or better was considered practically preferable and A was considered especially preferable.

A: ΔL is 0.8 or smaller

B: ΔL is 0.8 to smaller than 1.0

C: ΔL is 1.0 to smaller than 1.5

D: ΔL is 1.5 or larger

### (Storage Stability)

The prepared liquid developer was placed in a 50 mL volume glass sample bottle which was then capped, and the capped bottle was left undisturbed for 3 months under the atmosphere of constant temperature/humidity of 25° C./50%. The average particle size (D50) and viscosity (η) values of the liquid developer after the 3 months were measured by the methods as described above, and the storage stability was evaluated by the rate of increase from the values before the start of the test. The average particle size and the viscosity were each independently evaluated.

### (Storage Stability of Average Particle Size (D50))

A: (average particle size (D50) after the test)/(average particle size (D50) before the test)<1.1

B: 1.1≤(average particle size (D50) after the test)/(average particle size (D50) before the test)<1.2

C: 1.2≤(average particle size (D50) after the test)/(average particle size (D50) before the test)

The B rank or better was considered practically preferable and A was considered even better.

### (Storage Stability of Viscosity (η))

A: (viscosity (η) after the test)/(viscosity (η) before the test)<1.1

B: 1.1≤(viscosity (η) after the test)/(viscosity (η) before the test)<1.4

C: 1.4≤(viscosity (η) after the test)/(viscosity (η) before the test)

The B rank or better was considered practically preferable and A was considered even better.

TABLE 10

| | | | | Continuous | | | | | | |
|---|---|---|---|---|---|---|---|---|---|---|
| | Particle size | Viscosity | Image | printing stability | | Fixing | Anti-cold-offset | | Storage stability | |
| | (μm) | (mPa · s) | density | 500th sheet | 1000th sheet | rate (%) | property | ΔL | Particle size | Viscosity |
| Example 1 | 2.5 | 50 | 1.62 | A | A | 93 | A | A | B | A |
| Example 2 | 2.3 | 58 | 1.65 | A | A | 89 | A | A | B | A |
| Example 3 | 2.1 | 72 | 1.59 | A | A | 92 | A | B | A | B |
| Example 4 | 2.6 | 55 | 1.56 | A | A | 90 | A | A | A | B |
| Example 5 | 2.8 | 34 | 1.69 | A | A | 98 | A | A | A | A |
| Example 6 | 2.7 | 35 | 1.65 | A | A | 92 | A | A | A | A |
| Example 7 | 2.6 | 62 | 1.63 | A | A | 95 | A | A | B | A |
| Example 8 | 2.7 | 81 | 1.65 | A | A | 93 | A | A | B | B |
| Example 9 | 2.7 | 69 | 1.62 | A | A | 94 | A | A | B | A |
| Example 10 | 2.1 | 30 | 1.60 | A | A | 84 | A | A | A | A |
| Example 11 | 2.1 | 33 | 1.58 | A | A | 80 | B | A | A | A |
| Example 12 | 2.7 | 72 | 1.60 | A | A | 90 | A | A | B | B |
| Example 13 | 2.9 | 55 | 1.42 | A | A | 87 | A | A | B | A |
| Example 14 | 2.5 | 45 | 1.57 | A | A | 88 | A | A | A | B |
| Example 15 | 1.9 | 58 | 1.85 | A | A | 92 | A | A | A | B |
| Comparative Example 1 | 2.6 | 65 | 1.45 | C | C | 72 | B | B | B | B |
| Comparative Example 2 | 2.9 | 153 | 1.47 | A | A | 60 | B | D | C | B |
| Comparative Example 3 | 2.7 | 23 | 1.51 | C | C | 74 | D | B | B | B |
| Comparative Example 4 | 2.8 | 18 | 1.41 | A | A | 60 | D | A | B | B |
| Comparative Example 5 | 3.2 | 87 | 1.34 | A | A | 72 | C | A | D | D |
| Comparative Example 6 | 2.4 | 15 | 1.43 | A | A | 55 | D | A | B | B |
| Comparative Example 7 | 2.2 | 12 | 1.45 | A | A | 40 | D | A | B | B |
| Comparative Example 8 | 2.8 | 76 | 1.34 | B | C | 71 | B | B | B | B |
| Comparative Example 9 | 2.4 | 69 | 1.52 | B | C | 73 | B | A | B | B |
| Comparative Example 10 | 2.6 | 79 | 1.67 | B | C | 79 | B | B | B | B |

Comparative Examples 1, 3, and 8-10 showed poor continuous printing stability. It is believed that the carrier liquids' initial boiling point of lower than 200° C. or the dry point of lower than 300° C. made the volatility of the carriers too high and thus they were oxidized by the ozone generated from the charging device. Further, Comparative Example 3 had a D grade for the anti-cold-offset property. It is believed that this was affected by the difference of smaller 80° C. between the dry point and the initial boiling point which caused insufficient carrier liquid separation from the toner particles during the drying process. Comparative Example 2, on the other hand, showed poor fixing rate and AL. It is believed that this is because the carrier liquid's initial boiling point of higher than 250° C. made the volatility of the carrier lacking, thus a large portion of the energy during the fixing was used up for drying the carrier liquid, and the carrier liquid persisted on the recording medium even then.

In Comparative Example 5, the image density, anti-cold-offset property and storage stability were poor. It is believed that the reasons included the low acid value of the binder resin which provided insufficient adsorbing power even in the presence of the dispersing agent, and which made the affinity for the low volatility components of the carrier liquid (C) too high, resulting in poor separation of the carrier liquid. Conversely, Comparative Examples 4 and 6 had high acid values for the binder resins, which was believed to have caused excessive adsorption of the dispersing agents and thus, again, improper affinity for the low volatility components, impairing the fixability and the anti-cold-offset property. Comparative Example 7 employed different preparation method and was therefore believed to have near globular particles, resulting in reduced aggregation between the particles, which is believed to have impaired the fixability and the anti-cold-offset property.

In contrast, the liquid developers of Examples 1 to 15 showed excellent image density, fixability, anti-cold-offset property, and storage stability, as well as no streaks in the image, and also had superior continuous printing stability. In particular, Examples 5 and 6 had exceptionally good image density, fixability, and storage stability, as well as continuous printing stability, and were capable of providing printed materials with good image quality for an extended period of time.

### INDUSTRIAL APPLICABILITY

The liquid developers of the embodiments of the present invention can provide superior image qualities such as color reproducibility and color expression, continuous printing stability, and storage stability, and they can be suitably used as liquid developers for developing electrostatic latent images in electronic copiers, printers, on-demand image-forming devices and the likes in which the images are formed by employing electrophotography, electrostatic recording or the likes.

1. A liquid developer comprising at least: a toner particle comprising a binder resin (A) and a colorant (B); and a carrier liquid (C);
wherein the binder resin (A) has an acid value within the range of 20 to 40 mgKOH/g, and
the carrier liquid (C) is a non-aromatic hydrocarbon comprising an isoparaffin, wherein the carrier liquid (C) has an initial boiling point within the range of 200 to 250° C. and a dry point within the range of 300 to 450° C., and the difference between the dry point and the initial boiling point is 80 to 200° C.

2. The liquid developer of claim 1, further comprising a dispersing agent (D).

3. The liquid developer of claim 1, wherein the binder resin (A) comprises one or more resins selected from the group consisting of polyester resin, styrene resin, (meth)acryl resin, and styrene-(meth)acryl copolymer resin.

4. The liquid developer of claim 1, wherein the binder resin (A) comprises a polyester resin and one or more styrene/acryl resins selected from the group consisting of styrene resin, (meth)acryl resin, and styrene-(meth)acryl copolymer resin, wherein the styrene/acryl resin comprises a monomer having an aromatic ring within the range of 60 to 100% by mass in the total monomers constituting the styrene/acryl resin.

5. The liquid developer of claim 1, produced by a method comprising wet-grinding a melt-kneaded mixture of the binder resin (A) and the colorant (B) in the carrier liquid (C).

6. A method of producing a printed material obtained by using the liquid developer of claim 1.
